(19) United States
(12) Patent Application Publication
(10) Pub. No.: US 2019/0143705 A1
(43) Pub. Date: May 16, 2019

(54) INK CONTAINER FOR PHOTO-CURABLE INK

(71) Applicant: JETBEST CORPORATION, Hsinchu City (TW)

(72) Inventors: YI-CHING LU, HSINCHU CITY (TW); WENG-CHU CHU, HSINCHU CITY (TW); YUN-HSUAN CHEN, HSINCHU CITY (TW); CHUN-SHENG CHENG, HSINCHU CITY (TW)

(21) Appl. No.: 15/925,832

(22) Filed: Mar. 20, 2018

(30) Foreign Application Priority Data
Nov. 15, 2017 (TW) 106216983

(51) Int. Cl. B41J 2/175; B65D 81/30

(52) U.S. Cl. CPC B41J 2/17553; B41J 11/002; B65D 81/30; B41J 2/17566

(57) ABSTRACT

An ink container for photo-curable ink is disclosed, comprising a plurality of walls, the walls forming a closed space to be filled with UV photo-curable ink; the walls are non-transparent filter plates, but have light transmittance property, in a color scheme of yellow or orange, i.e., hue number of 3-8 in the PCCS hue circle, able to shield off the UV, the light transmittance property of the walls allows observing liquid level inside the ink container after filling with the UV photo-curable ink.

### TECHNICAL FIELD

The technical field generally relates to an ink container, and in particular, to a container for UV photo-curable ink, able to block the UV light while showing the height of the ink level inside the container.

### BACKGROUND

UV photo-curable ink does not contain a vaporized organic compound and is able to dry rapidly (curing) upon receiving light of specific wavelength to achieve instantaneous printing and drying, suitable for printing on various materials, such as, glass, wood, acrylic, PVC plastic, metal, leather, porcelain, and so on. The photo-curable ink is widely used in printing industry. The UV photo-curable ink must be shielded from UV light before printing; thus, the ink container/cartridge or ink transmission tubes used by the printer must shield the light off to prevent the light from pre-maturely curing the ink.

The continuous ink supply system is used by many printers. The system uses replaceable ink cartridges that are transparent or highly translucent, which allow the user to observe and determine the liquid level inside the ink cartridge while unable to see the ink inside the cartridge clearly. As such, the user can determine or plan when to replace the ink cartridge, instead of waiting for the printer to issue an out-of-ink signal. However, this type of ink cartridge cannot be used by the UV photo-curing ink as the cartridge is unable to completely shield of the UV light. It is imperative to devise a solution to address the above issue.

### SUMMARY

The object of the present invention is to provide an ink container for photo-curable ink, which is able to effectively shield off light of specific wavelength, such as, UV light, without affecting the observation to determine the liquid level inside the ink container so as to be used in the continuous ink supply system or storage for UV photo curable ink.

To achieve the above object, the present invention provides an ink container, formed by a plurality of surrounding walls, the walls forming a closed space to be filled with UV photo-curable ink; the walls are non-transparent filter plates, but has light transmittance property, in a color scheme of yellow or orange, i.e., hue number of 3-8 in the PCCS hue circle, able to shield off the UV. Also the light transmittance property of the walls allows the observation of the liquid level inside the ink container after filling with the ink.

Moreover, the walls are made of at least one of the materials of PP, PE, and PBT, with a thickness of 2-6 mm. As such, the walls are translucent plates, and become the non-transparent filter plates with light transmittance property.

The ink container is designed as in the color scheme of yellow or orange, which is similar to a filter plate so as to block the UV light of wavelength in the range of 200-500 nm. With the thickness of 2-6 mm, the walls are translucent. After filling with UV photo curable ink, the walls of the ink container above and below the ink level will show different luminance to allow the user to determine the liquid level of the ink inside the ink container.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of the ink container according to an exemplary embodiment of the present invention;

FIG. 2 shows a cross-sectional view along the AA line in FIG. 1;

FIG. 3 shows a schematic view of the present invention;

FIG. 4 shows a schematic view of the present invention in actual application.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

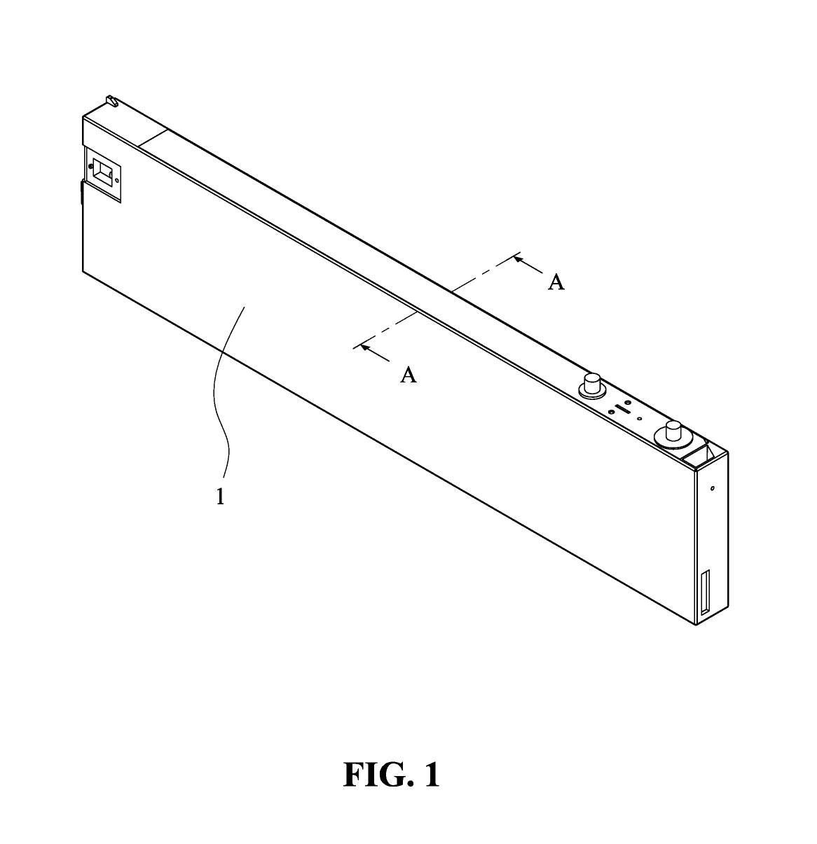

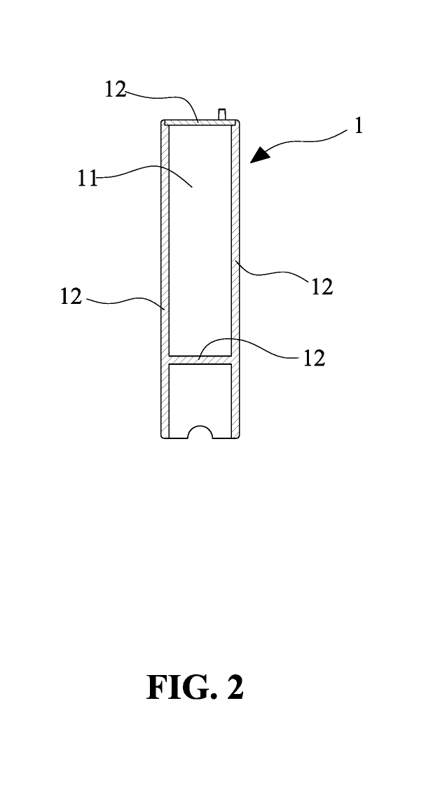

FIG. 1 and FIG. 2 show a schematic view and a cross-sectional view of the ink container according to an exemplary embodiment of the present invention respectively. As shown in the present embodiment, the ink container is an ink cartridge 1, with at least space 11 inside the ink cartridge for filling with UV photo curable ink. The shape and structure of the ink cartridge 1 depend on the type of printer to be used with. In the present embodiment, the ink cartridge 1 is, but not limited to, a replaceable ink cartridge used in a continuous ink supply system.

The structure of the ink cartridge 1 must be able to effectively block the UV light of the 360-400 nm wavelength, but still with appropriate light transmittance property to allow the user to observe the liquid level inside the ink cartridge 1. The ink cartridge 1 is formed by a plurality of walls 12, and the walls 12 surround to form the closed space 11. The walls 12 are made of at least one of the materials of Polypropylene (PP), Polyethylene (PE), and Polybutylene terephthalate (PBT). The thickness of the walls 12 ranges 0.5-6 mm, preferably, 2-6 mm. The color scheme of the walls is yellow or orange, i.e., the hue number 3-8 in the Practical Color Co-ordinate System (PCCS) hue circle. As such, the walls 12 is non-transparent, but still with light transmittance property.

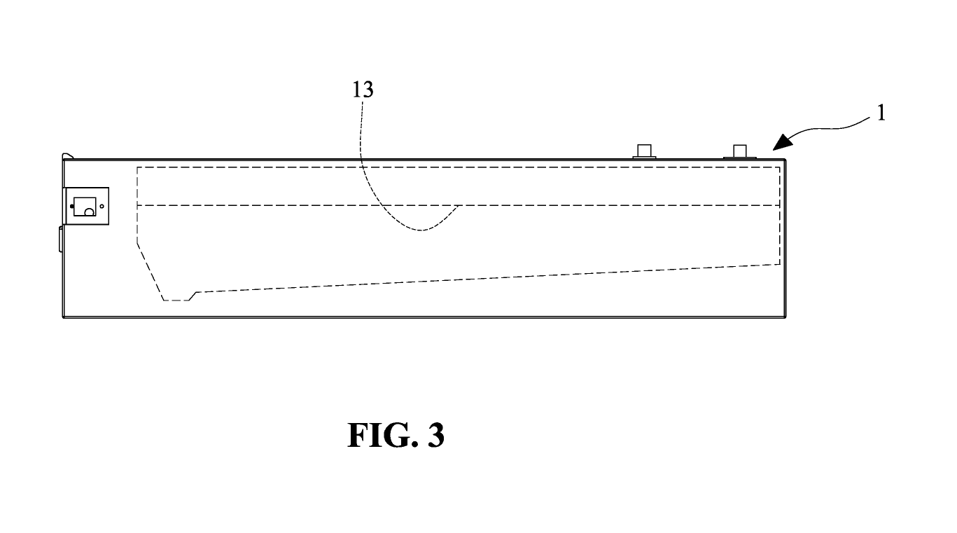

The color of the walls 12 is obtained by adding dye to the aforementioned plastic materials to form the color scheme of yellow or orange. Because of the specific color of the walls 12, the ink cartridge can effectively block the UV light of 200-500 nm wavelength to prevent the UV photo curable ink inside the ink cartridge 1 from pre-maturely curing. The preferred embodiment of the ink cartridge is able to block the UV light of 360-400 nm. Hence, the ink quality is preserved. The walls 12 have a thickness of 2-6 mm. As such, the walls 12 are translucent plates, and with light transmittance property to allow the user to determine by observing the liquid level 13 of the ink inside the ink cartridge 1, as shown in FIG. 3. Hence, in actual application, the user is able to estimate or plan the time to replace the ink cartridge 1 depending on the observed liquid level 13, instead of waiting for the printer to issue an out-of-ink warning.

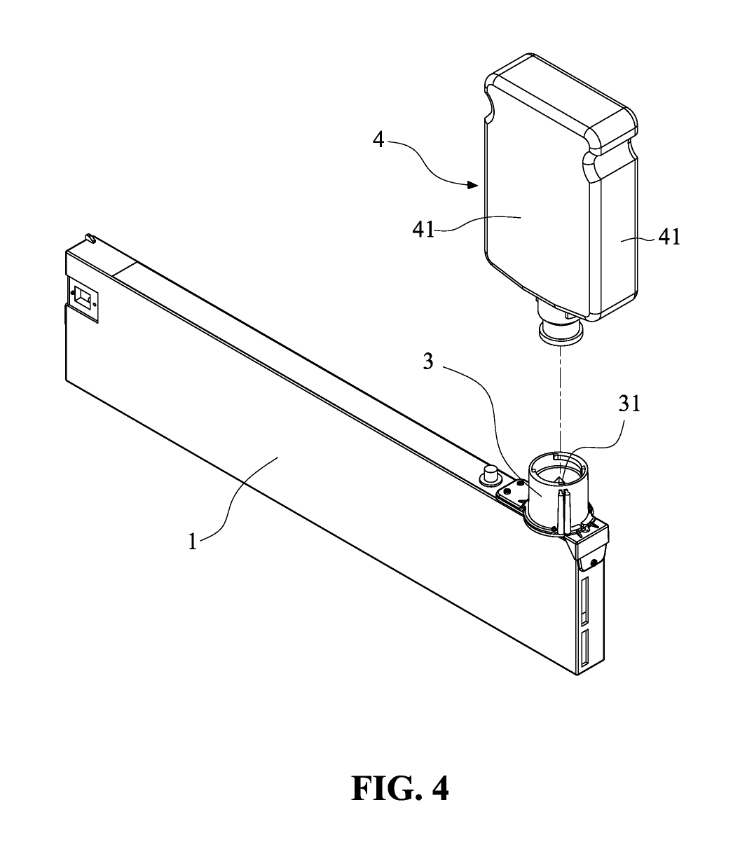

As shown in FIG. 4, in actual application, the present invention is installed with a connection unit 3 to the top of the ink cartridge 1. The connection unit 3 is disposed with a protruding sharp element 31, which has a via hole and related tubes for connecting to the space inside the ink cartridge 1. Moreover, an ink supplementary bottle 4 is included and disposed with a rubber cork at the mouth of the bottle 4, which is not seen in FIG. 4 as the mouth of the bottle faces downward. When the user aligns the rubber cork of the ink bottle 4 with the protruding sharp element 31, and presses the protruding sharp element 31 to penetrate the rubber cork, the ink inside the ink bottle 4 can be continuously supplied to the ink cartridge 1. When the ink is used up, the ink bottle 4 can be replaced. In the present scenario, the ink bottle 4 is also an ink container for UV photo curable ink. Therefore, the ink bottle 4 is formed by surrounding walls 41, which form a closed space for filling with UV photo curable ink. The walls 41 are non-transparent filter plates, but with light transmittance property.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An ink container for photo-curable ink, comprising a plurality of walls, the walls forming a closed space to be filled with UV photo-curable ink; the walls being non-transparent filter plates, but having light transmittance property, in a color scheme of yellow or orange, hue number of 3-8 in the PCCS hue circle, able to shield off the UV, the light transmittance property of the walls allowing observing liquid level inside the ink container after filling with the UV photo-curable ink.

2. The ink container for photo-curable ink as claimed in claim 1, wherein the walls are made of at least one of the following materials: PP, PE, and PBT; and the walls have a thickness of 0.5-6 mm.

3. The ink container for photo-curable ink as claimed in claim 1, wherein the ink container blocks the UV light of 200-500 nm wavelength.

4. The ink container for photo-curable ink as claimed in claim 1, wherein the ink container is an ink cartridge.

5. The ink container for photo-curable ink as claimed in claim 1, wherein the ink container is an ink bottle.
